(19) United States
(12) Patent Application Publication
(10) Pub. No.: US 2017/0133138 A1
(43) Pub. Date: May 11, 2017

(54) SOLENOID SYSTEM WITH AN ARMATURE POSITION SENSOR

(71) Applicant: PONTIAC COIL, INC., Clarkston, MI (US)

(72) Inventors: Weston C. Bye, Clarkston, MI (US); Andrew M. Roberts, Clarkston, MI (US); Jeffrey Reddy, Clarkston, MI (US)

(21) Appl. No.: 15/175,096

(22) Filed: Jun. 7, 2016

Related U.S. Application Data
(60) Provisional application No. 62/252,837, filed on Nov. 9, 2015.

(51) Int. Cl. H01F 7/08; G01D 5/12; F16H 61/02

(52) U.S. Cl. CPC H01F 7/081; F16H 61/0204; G01D 5/12

(57) ABSTRACT

A solenoid system for a vehicle can include an electromagnetic device, permanent magnet, and sensor. The electromagnetic device can include a housing, armature, and solenoid to move the armature axially relative to the housing. When the armature is in an extended position, a first end of the armature can extend further in a first direction relative to the housing than when in a retracted position. The sensor can be fixedly coupled to the housing and can detect a magnetic field of a permanent magnet based on the position of the armature.

### CROSS-REFERENCE TO RELATED APPLICATIONS

This application claims the benefit of U.S. Provisional Application No. 62/252,837, filed on Nov. 9, 2015. The entire disclosure of the above application is incorporated herein by reference.

### FIELD

The present disclosure relates to a solenoid system with an armature position sensor.

### BACKGROUND

This section provides background information related to the present disclosure which is not necessarily prior art.

Solenoids are often used in systems to linearly move a component of that system. One such system is found in modern automobiles equipped with automatic transmissions, which typically include a Park Lock feature and a Brake Transmission Shift Interlock (“BTSI”) feature, such as that described in U.S. Pat. No. 6,592,492 B1 for example. Conventional automatic transmissions include a shifter or shift lever movable to a plurality of positions for selecting one of several different operating modes of the transmission. These operating modes typically include a park mode, a reverse mode, and any number of forward drive modes (e.g., drive/overdrive, first gear, second gear, etc.).

The BTSI is an electromechanical device used to prevent the vehicle's transmission from being shifted out of the “Park” position unless the vehicle's brake is pressed. A BTSI typically includes a solenoid that includes a pin coupled to an armature assembly. Typically, the solenoid changes states between an energized or activated state and a deenergized or deactivated state depending, at least in part, on whether or not the vehicle's brake is pressed. When activated, the solenoid causes the armature to extend to cause the pin to extend. The pin mechanically prevents the vehicle's transmission from being shifted out of the “Park” position when the armature and pin are extended. When the vehicle's brake is pressed, the armature retracts, which causes the pin to also retract. With the pin retracted, the vehicle transmission can be shifted from the “Park” position to another position, such as neutral, drive, or reverse positions.

In some situations, the pin or armature assembly of typical BTSIs can become stuck in either the extended position or the retracted position regardless of the intended state of the solenoid. Such malfunctions can permit the vehicle's transmission to be shifted out of “Park” even though the vehicle's brake is not pressed, or cause the shifter to be stuck in “Park” even when the brake is pressed. Accordingly, there is a need for a mechanism for providing feedback to the vehicle system regarding the actual operational state of the pin or armature of the BTSI.

### SUMMARY

This section provides a general summary of the disclosure, and is not a comprehensive disclosure of its full scope or all of its features.

A device can be added to a BTSI assembly to detect whether the physical state of the release pin/armature assembly matches the intended state. In certain embodiments, the device is a Hall Effect sensor and a permanent magnet, which are integrated with a BTSI assembly. The Hall Effect sensor is configured to detect the physical position of the pin/armature assembly of the solenoid of the BTSI and provide a feedback signal indicative of the position off the pin/armature assembly. In other embodiments, the device is a micro switch adapted to determine the position of the release pin/armature assembly.

The present teachings provide for a solenoid system for a vehicle including an electromagnetic device, a permanent magnet, and a sensor. The electromagnetic device can include a housing, an armature, and a solenoid coil. The solenoid coil can be configured to move the armature axially between an extended position and a retracted position relative to the housing. The armature can have a first end and a shunt portion. The shunt portion can be formed of a ferrous material. When the armature is in the extended position, the first end of the armature can extend further in a first direction relative to the housing than when the armature is in the retracted position. A permanent magnet can be fixedly coupled to the housing. The sensor can be fixedly coupled to the housing. The sensor can be configured to detect a magnetic field of the permanent magnet when the armature is in one of the extended position or the retracted position. When the armature is in the other of the extended position or the retracted position, the shunt portion of the armature can be disposed between the sensor and the permanent magnet to reduce a strength of the magnetic field at the sensor.

The present teachings further provide for a solenoid system for a vehicle including an electromagnetic device, a permanent magnet and a sensor. The electromagnetic device can include a housing, an armature, and a solenoid coil. The solenoid coil can be configured to move the armature axially between an extended position and a retracted position relative to the housing. When the armature is in the extended position, a first end of the armature can extend further in a first direction relative to the housing than when the armature is in the retracted position. The permanent magnet can be fixedly coupled to the armature for common axial movement therewith and can extend radially outward from the armature. The sensor can be fixedly coupled to the housing and can be configured to detect a magnetic field of the permanent magnet when the armature is in one of the extended position or the retracted position. The permanent magnet can be disposed axially further from the sensor when the armature is in the other of the extended position or the retracted position.

The present teachings further provide for a solenoid system for a vehicle including an electromagnetic device, a permanent magnet and a sensor. The electromagnetic device can include a housing, an armature, and a solenoid coil. The solenoid coil can be configured to move the armature axially between an extended position and a retracted position relative to the housing. When the armature is in the extended position, a first end of the armature can extends further in a first direction relative to the housing than when the armature is in the retracted position. The permanent magnet can be fixedly coupled to the armature for common axial movement therewith. The permanent magnet can have a first pole at a first axial end of the permanent magnet and a second pole at a second axial end of the permanent magnet. The sensor can be fixedly coupled to the housing and can be configured to detect a magnetic field of the permanent magnet when the armature is in one of the extended position or the retracted position. The sensor can be disposed axially between the first and second poles of the permanent magnet when the armature is in the other of the extended position or the retracted position.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a portion of a vehicle transmission shift mechanism, illustrating a Brake Transmission Shift Interlock with a solenoid system in accordance with the present disclosure;

FIG. 2 is a perspective view of the solenoid system of FIG. 1;

FIG. 3 is a sectional view of a portion of the solenoid system of FIG. 2, illustrating an armature of the solenoid system in a first position;

FIG. 4 is a sectional view of a portion of the solenoid system of FIG. 2, illustrating the armature in a second position;

FIG. 5 is a sectional view of a portion of a solenoid system of a second construction;

FIG. 6 is a top plan view of the portion of the solenoid system of FIG. 5;

FIG. 7 is a sectional view of a portion of a solenoid system of a third construction, illustrating an armature of the solenoid system in a first position;

FIG. 8 is a sectional view similar to FIG. 8, illustrating the armature in a second position; and

FIG. 9 is a sectional view of a portion of a solenoid system of a fourth construction.

Corresponding reference numerals indicate corresponding parts throughout the several views of the drawings.

### DETAILED DESCRIPTION

Example embodiments will now be described more fully with reference to the accompanying drawings.

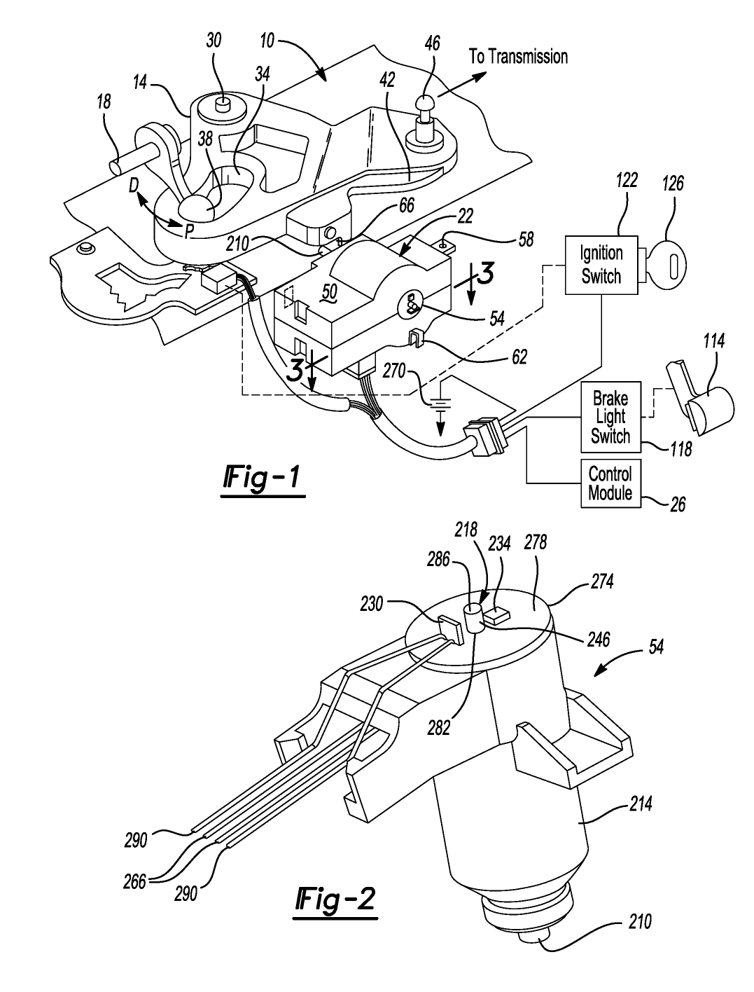

With reference to FIG. 1, an example of a portion of a vehicle transmission shift mechanism is illustrated. In the example provided, the vehicle transmission shift mechanism is located on a steering column 10 of the vehicle, though other configurations can be used. It is understood that the transmission shift mechanism can be any suitable device for selecting the operating mode of the transmission, such as column mounted mechanisms, console mounted mechanisms or shift-by-wire mechanisms for example. In the example provided, the transmission shift mechanism includes a crank member 14, a shift lever 18, a Brake Transmission Shift Interlock (“BTSI”) 22, and a control module 26. The transmission shift mechanism can be similar to the transmission shift mechanism described in U.S. Pat. No. 6,592,492 B1, except as otherwise shown or described herein, and the entire disclosure of U.S. Pat. No. 6,592,492 B1 is incorporated herein by reference.

The crank member 14 can be mounted on the steering column 10 to rotate about a pivot 30. The crank member 14 can be formed with a cam opening 34. A ball 38 can be mounted to the shift lever 18 and received in the cam opening 34. The ball 38 can be mechanically attached to the shift lever 18 to be moved by the shift lever 18 in the directions indicated by arrows (P) and (D). In the example provided, arrow (P) indicates a direction toward a “Park” position and arrow (D) indicates a direction from the “Park” position to a different position, such as a “Drive” position, a “Reverse” position, or a “Neutral” position for example. A distal portion 42 of the crank member 14 can be fitted with a connector 46 to receive a mechanical push-pull cable (not specifically shown) which can connect the crank member 14 to a transmission (not specifically shown) of the vehicle, though other configurations can be used. Movement of the ball 38 and the shift lever 18 can cause associated pivotal motion of the crank member 14 about the pivot 30 that can cause a corresponding change of a mode of the transmission (e.g., to and from a “Park” mode).

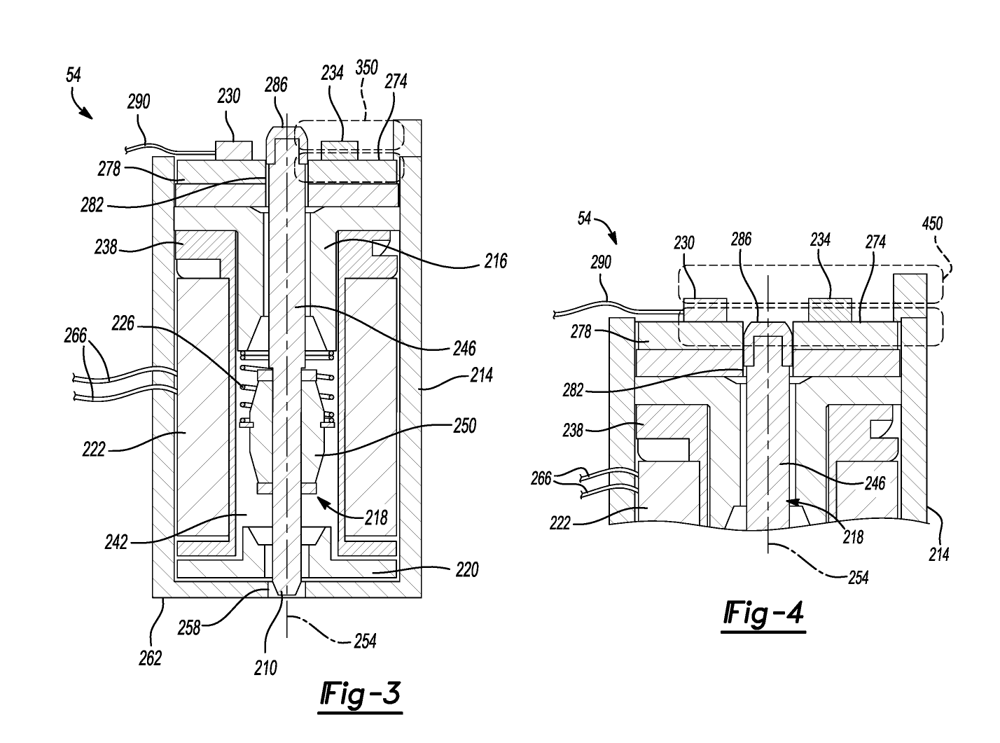

The BTSI 22 can have a BTSI housing 50 and a linear motor device (e.g., a solenoid 54). The housing 50 can be fixedly mounted to the steering column 10, such as by brackets 58 and 62. With additional reference to FIGS. 2 and 3, the solenoid 54 can be fixedly mounted to the housing 50. The solenoid 54 can include a blocking/unblocking member or pin 210, a solenoid housing 214, a first pole piece 216, an armature 218, a second pole piece 220, a coil 222, a spring 226, a Hall Effect sensor 230, and a permanent magnet 234.

The solenoid housing 214 can be fixedly coupled to or integrally formed with the housing 50. The armature 218, coil 222, and spring 226 can be located within the solenoid housing 214 and positioned in a conventional manner that need not be described in detail herein. In general, the coil 222 can be disposed about a bobbin 238 that can define a central cavity 242 within the solenoid housing 214. The armature 218 can include an armature rod 246 and an armature core 250. The armature core 250 can be a ferromagnetic material, such as iron for example, and can be fixedly mounted to the armature rod 246 for linear motion along a central axis 254 with the armature rod 246. The armature core 250 can be disposed within the central cavity 242 and surrounded by the coil 222. The pin 210 can be fixedly coupled to or integrally formed with one end of the armature rod 246. The armature 218 can be axially movable between a retracted position (shown in FIG. 3) and an extended position (shown in FIG. 4). When the armature 218 is in the extended position, the pin 210 extends through an aperture 258 at one end 262 of the solenoid housing 214 a greater distance than when the armature 218 is in the retracted position.

The coil 222 can be electrically coupled to a pair of control signal lines 266 that can be electrically coupled to a source of power (e.g., battery 270, shown in FIG. 1) to provide electrical current to the coil 222. Providing electrical current to the coil 222 energizes or activates the coil 222 and produces a magnetic field that can act on the armature core 250 to move the armature core 250 and armature rod 246 linearly along the axis 254. In the example provided, the spring 226 can bias the armature 218 axially toward the extended position (shown in FIG. 4). Energizing the coil 222 can apply a magnetic force on the armature core 250 that can overcome the biasing force of the spring 226 to cause the armature 218 to move to the retracted position (shown in FIG. 3). The magnetic field produced by the coil 222 can flow through the solenoid housing 214, the second pole piece 220, and the armature core 250 when in the retracted position, to hold the armature 218 in the retracted position while the coil 222 is energized. When the coil 222 is de-energized or deactivated, the spring 226 can return the armature 218 to the extended position. In an alternative configuration, the spring 226 can bias the armature 218 toward the retracted position, while energizing the coil 222 can cause the armature 218 to move to the extended position.

Returning to FIG. 1, when the armature 218 (shown in FIGS. 2-4) is in the extended position, the pin 210 can engage a projection 66 of the crank member 14. Engagement of the pin 210 with the projection 66 can prevent the crank member 14 from being pivoted in the direction (D) to prevent the transmission (not specifically shown) from being shifted out of the “Park” mode. When the armature 218 (shown in FIGS. 2-4) is in the retracted position, the pin 210 can be disengaged from the projection 66 to permit the crank member 14 to pivot in the direction (D) and allow the transmission (not specifically shown) to be shifted out of the “Park” mode.

In operation, pressing of a brake pedal 114 can trigger a brake light switch 118. The brake light switch 118 can be electrically coupled to the BTSI 22 and/or the control module 26 to send signals thereto indicative of the brake pedal 114 being pressed. An ignition switch 122 can also be electrically coupled to the BTSI 22 and/or the control module 26 to send signals thereto indicative of the ignition switch 122 being in a predetermined condition (e.g., a “Run” position), such as by rotation of an authorized key 126 for example. The control module 26 can be configured to change the state of the BTSI 22 to cause the armature 218 (shown in FIGS. 2-4) to move to the retracted position in response to a condition wherein both the ignition switch 122 is in the predetermined condition and the brake pedal 114 is pressed. In the example provided, when the ignition switch 122 is in the predetermined condition and the brake pedal 114 is pressed, the control module 26 can activate the coil 222 (FIG. 2) to move the armature 218 (shown in FIGS. 2-4) to the retracted position, such that the pin 210 no longer prohibits the crank member 14 from rotating about the pivot 30 out of the “Park” position.

Returning to FIGS. 2-4, the Hall Effect sensor 230 can be mounted to an end 274 of the solenoid housing 214 that is opposite the end 262 through which the pin 210 extends. In the example provided, the Hall Effect sensor 230 is mounted to a printed circuit board 278 located at the end 274 of the solenoid housing 214, though other configurations can be used. In the example provided, the printed circuit board 278 and solenoid housing 214 can define an aperture 282. The permanent magnet 234 can be mounted to the printed circuit board 278 on the other side of the aperture 282 from the Hall Effect sensor 230 (i.e., diametrically opposite the Hall Effect sensor 230).

An end 286 of the armature rod 246 can extend through the aperture 282 when the armature 218 is in the retracted position (shown in FIG. 3), such that the end 286 is disposed radially between the Hall Effect sensor 230 and the permanent magnet 234. When the armature 218 is in the extended position (shown in FIG. 4), the end 286 of the armature rod 246 can be retracted into the solenoid housing 214, such that the end 286 is not between the Hall Effect sensor 230 and the permanent magnet 234. The end 286 of the armature rod 246 can be made of a ferromagnetic material. In the example provided, the rest of the armature rod 246, not including the ferrous end 286, can be formed of a non-ferromagnetic material.

When the armature 218 is in the retracted position (shown in FIG. 3), the ferrous end 286 of the armature rod 246 is disposed between the Hall Effect sensor 230 and the permanent magnet 234 and shunts or blocks the magnetic field (schematically shown as dashed lines 350), such that the magnetic field does not reach the Hall Effect sensor 230, or is detectably weaker at the Hall Effect sensor 230 than when the armature 218 is in the extended position (shown in FIG. 4). When the armature 218 is in the extended position, the magnetic field (schematically shown by dashed lines 450) of the permanent magnet 234 can extend over the aperture 282 to be detected by the Hall Effect sensor 230. When the armature 218 is in the extended position, the ferrous end 286 does not interfere with the magnetic field being detected by the Hall Effect sensor 230.

The Hall Effect sensor 230 can be an analog or digital type Hall Effect sensor. The number of wires connected to the Hall Effect sensor can vary, but two non-limiting examples include a conventional 2-wire Hall Effect sensor or a conventional 3-wire Hall Effect sensor. The Hall Effect sensor 230 can be electrically coupled to output signal lines 290 (e.g., two output signal lines in the case of a 2-wire Hall Effect sensor, or three output signal lines in the case of a S-wire Hall Effect sensor) which output a signal to the control module 26 (FIG. 1). The output signal can be indicative of the presence or the strength (depending on the type of Hall Effect sensor) of the magnetic field of the permanent magnet 234 that is detected by the Hall Effect sensor 230. Thus, the Hall Effect sensor 230 can provide feedback to the vehicle's control module 26 (FIG. 1) as to the actual physical position of the pin 210 and armature 218 regardless of whether the coil 222 is activated or deactivated. In other words, the Hall Effect Sensor 230 provides an output signal on the output signal lines 290 indicative of whether it senses the magnetic field or not, or the strength of the magnetic field, which in turn is indicative of whether or not the pin 210 is engaging the projection 66 of the crank member 14 to prevent the crank member 14 from pivoting and shifting the transmission out of the “Park” mode.

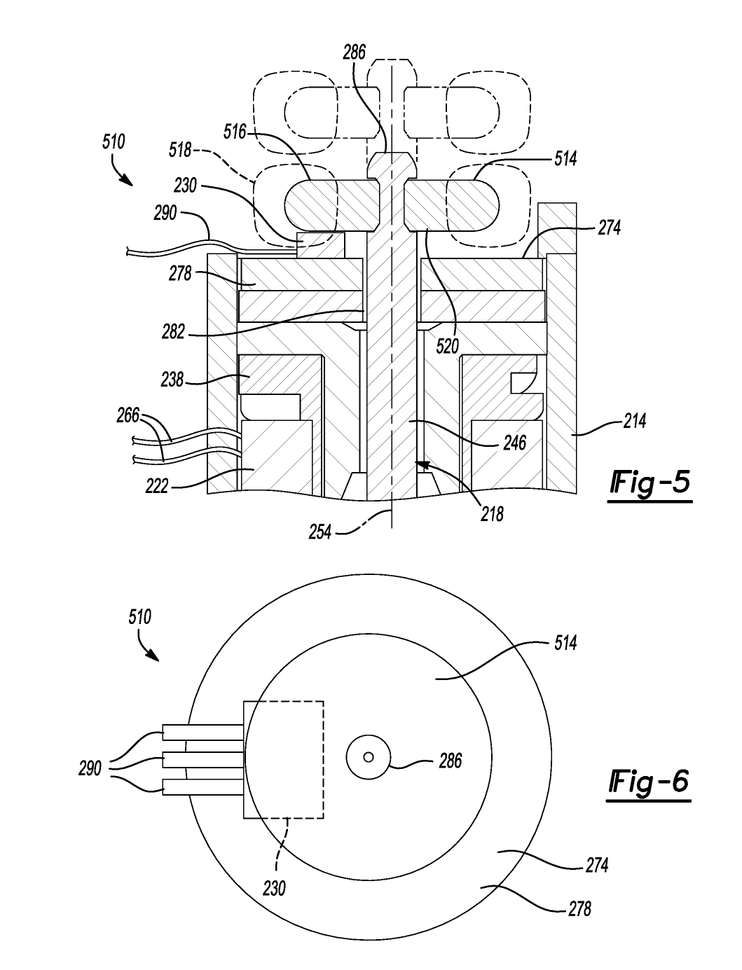

With additional reference to FIGS. 5 and 6, a portion of a solenoid 510 of a second construction is illustrated. The solenoid 510 can be similar to the solenoid 54 (FIGS. 1-4) except as otherwise illustrated or described herein. In the example shown in FIGS. 5 and 6, a permanent magnet 514 is fixedly mounted to the end 286 of the armature rod 246. In the example provided, the permanent magnet 514 is an annular shape disposed about the end 286 of the armature rod 246. The permanent magnet 514 extends radially outward to overlap with the Hall Effect sensor 230, such that the Hall Effect sensor 230 is axially between the permanent magnet 514 and the printed circuit board 278. Thus, the Hall Effect sensor 230 can be at least partially radially inward of an outer circumference of the permanent magnet 514. In the example provided, the permanent magnet 514 has one pole (e.g., north pole) at an upper side 516 of the permanent magnet 514 and the opposite pole (e.g., south pole) at a lower side 520 of the permanent magnet 514, such that the Hall Effect sensor 230 is between the lower side 520 (e.g., the south pole) and the solenoid housing 214 regardless of whether the armature 218 is in the extended or retracted position. When the armature 218 is in the extended position (i.e., the lock-out position, shown in solid lines in FIG. 5), the permanent magnet 514 is axially closer to the Hall Effect sensor 230 than when the armature 218 is in the retracted position (shown in dashed lines in FIG. 5). When the armature 218 is in the extended position, a magnetic field 518, or a strong region of the magnetic field, of the permanent magnet 514 can pass through the Hall Effect sensor 230. When the armature 218 is in the retracted position, the magnetic field 518 can be such that it does not pass through the Hall Effect sensor 230, or at least the magnetic field that reaches the Hall Effect sensor 230 can be weaker than when in the extended position.

The Hall Effect sensor 230 can output an output signal indicative of the presence or the strength of the magnetic field 518 of the permanent magnet 514 that passes through the Hall Effect sensor 230. The control module 26 (FIG. 1) can receive this output signal and determine the proximity of the permanent magnet 514 relative to the Hall Effect sensor 230 to determine the physical position of the armature 218 in either the extended position or the retracted position as otherwise described above. Thus, the Hall Effect sensor 230 is arranged in a “proximity” configuration.

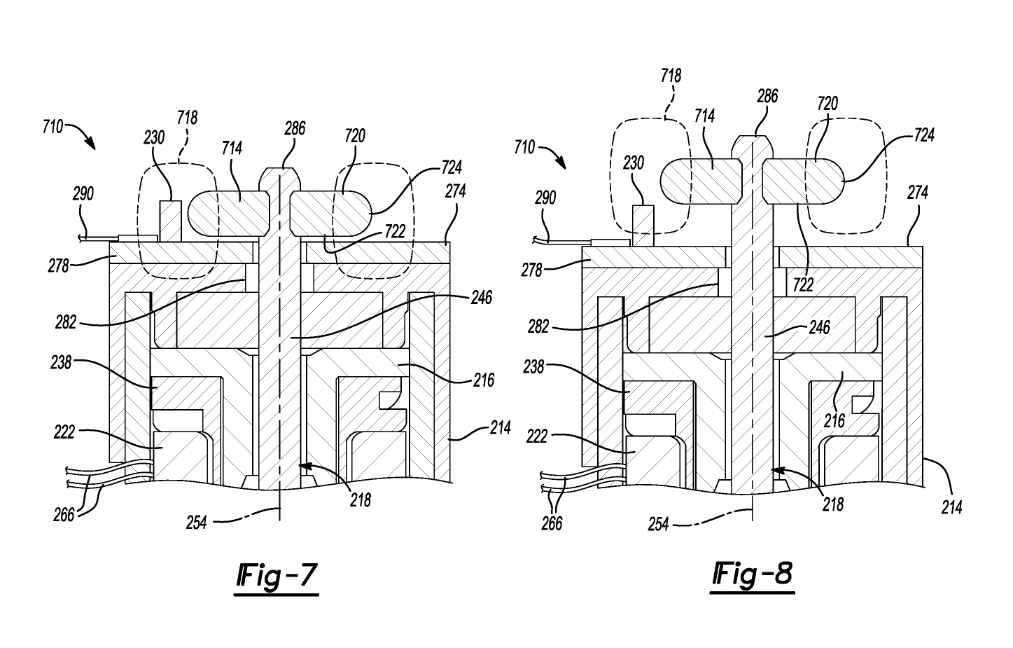

With additional reference to FIGS. 7-8 a portion of a solenoid 710 of a third construction is illustrated. The solenoid 710 can be similar to the solenoid 54 (FIGS. 1-4) except as otherwise illustrated or described herein. In the example shown in FIGS. 7-8, a permanent magnet 714 is fixedly mounted to the end 286 of the armature rod 246. In the example provided, the permanent magnet 714 is an annular shape disposed about the end 286 of the armature rod 246. The permanent magnet 714 extends radially outward such that the permanent magnet 714 does not overlap with the Hall Effect sensor 230. In this construction, the Hall Effect sensor 230 is radially outward of the permanent magnet 714 and is axially aligned with the permanent magnet 714 when the armature 218 is in the extended position (i.e., the lock-out position, shown in FIG. 7). When the armature 218 is in the retracted position (shown in FIG. 8), the permanent magnet 714 is axially further from the Hall Effect sensor 230 than when the armature is in the extended position.

The permanent magnet 714 can produce a magnetic field (schematically shown as dashed lines 718 in FIGS. 7 and 8). When the armature 218 is in the extended position (shown in FIG. 7), the magnetic field generally surrounds the Hall Effect sensor 230 such that the magnetic field, or at least the strongest areas of the magnetic field, do not pass through the Hall Effect sensor 230. In the example provided, the permanent magnet 714 has one pole (e.g., north pole) at an upper side 720 and the opposite pole (e.g., south pole) at a lower side 722 of the permanent magnet 714, while an outer circumference 724 of the permanent magnet 714 can generally form the polar middle of the permanent magnet 714. The upper side 720 and lower side 722 can face in opposite axial directions, while an outer circumference 724 of the permanent magnet 714 faces toward the Hall Effect sensor 230, such that when the armature 218 is in the extended position (shown in FIG. 7), the Hall Effect sensor 230 aligns axially with the outer circumference 724, or between the two poles (i.e., the upper and lower sides 720, 722). In this way, the Hall Effect sensor 230 is located in the fringe, or weakest part, of the magnetic field of the permanent magnet 714 when the armature 218 is in the extended position. When the armature 218 is in the retracted position (shown in FIG. 8), the magnetic field, or the strongest part of the magnetic field, passes through the Hall Effect sensor 230.

The Hall Effect sensor 230 can output an output signal indicative of the presence or strength of the magnetic field produced by the permanent magnet 714. The control module 26 (FIG. 1) can receive this output signal and determine the position of the permanent magnet 714 relative to the Hall Effect sensor 230 to determine the physical position of the armature 218 in either the extended position or the retracted position as otherwise described above. Thus, the Hall Effect sensor 230 is arranged in a “fringe” configuration.

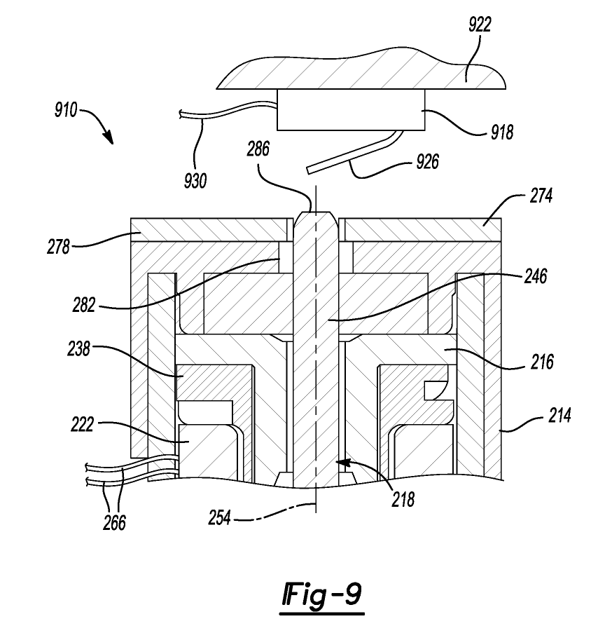

With additional reference to FIG. 9, a portion of a solenoid 910 of a fourth construction is illustrated. The solenoid 910 can be similar to the solenoid 54 (FIGS. 1-4) except as otherwise shown or described herein. The solenoid 910 can include a micro switch 918. The micro switch 918 can be mounted to a support structure 922. The support structure 922 can be fixedly coupled to the housing 50 (shown in FIG. 1) or to another structure fixed relative to the solenoid housing 214. In this construction, the spring 226 (shown in FIG. 3) can bias the armature 218 toward the extended position. When the coil 222 is energized, the armature 218 can move to the retracted position and the pin 210 can engage a switch member 926 of the micro switch 918 to actuate the micro switch 918. In the example provided, the switch member 926 is a pivoting lever arm, though other configurations can be used.

When the micro switch 918 is actuated, the micro switch 918 can provide a signal to the control module 26 (FIG. 1), via wires 930, indicative that the armature 218 is in the retracted position. When the coil 222 is de-energized, the spring 226 (shown in FIG. 3) can return the armature 218 to the extended (i.e., lock-out) position and the micro switch 918 can be disengaged. When the micro switch 918 is disengaged, the micro switch 918 can signal to the control module 26 (FIG. 1) that the armature 218 is in the extended position. It is understood that the micro switch 918 can be configured in other manners such that an absence of a signal received from the micro switch 918 can be indicative of either the extended state or the retracted state, while the presence of a signal from the micro switch 918 can be indicative of the opposite state.

While not specifically shown, any of the solenoids 54, 510, 710, or 910 can also include a manual release lever similar to that described in U.S. Pat. No. 6,592,492 B1, which can be pivotably mounted to the housing 50 (shown in FIG. 1) of the BTSI 22 and be configured to engage the end 286 (shown in FIGS. 2-9) of the armature rod 246 (shown in FIGS. 2-9) to manually move the armature 218 (shown in FIGS. 2-4) from the extended position to the retracted position.

Those of skill in the art will appreciate that, while the solenoid 54 is described herein with reference to a BTSI 22, the solenoid 54 can be used in other applications.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A solenoid system comprising:
an electromagnetic device including a housing, an armature, and a solenoid coil, the solenoid coil configured to move the armature axially between an extended position and a retracted position relative to the housing, the armature having a first end and a shunt portion, the shunt portion being formed of a ferrous material, wherein when the armature is in the extended position, the first end of the armature extends further in a first direction relative to the housing than when the armature is in the retracted position;
a permanent magnet fixedly coupled to the housing;
a sensor fixedly coupled to the housing, the sensor being configured to detect a magnetic field of the permanent magnet when the armature is in one of the extended position or the retracted position, wherein when the armature is in the other of the extended position or the retracted position, the shunt portion of the armature is disposed between the sensor and the permanent magnet to reduce a strength of the magnetic field at the sensor.

2. The solenoid system of claim 1, wherein the electromagnetic device includes a spring that biases the armature toward one of the extended position or the retracted position.

3. The solenoid system of claim 1, wherein the shunt portion is disposed at a second end of the armature that is opposite the first end of the armature.

4. The solenoid system of claim 3, wherein when the armature is in the extended position, the first end of the armature extends through an aperture in a first end of the housing, and wherein when the armature is in the retracted position, the second end of the armature extends axially through an aperture in a second end of the housing that is opposite the first end of the housing.

5. A solenoid system comprising:
an electromagnetic device including a housing, an armature, and a solenoid coil, the solenoid coil configured to move the armature axially between an extended position and a retracted position relative to the housing, wherein when the armature is in the extended position, a first end of the armature extends further in a first direction relative to the housing than when the armature is in the retracted position;
a permanent magnet fixedly coupled to the armature for common axial movement therewith and extending radially outward from the armature;
a sensor fixedly coupled to the housing and configured to detect a magnetic field of the permanent magnet when the armature is in one of the extended position or the retracted position, wherein the permanent magnet is disposed axially further from the sensor when the armature is in the other of the extended position or the retracted position.

6. The solenoid system of claim 5, wherein the sensor is disposed axially between the permanent magnet and the housing.

7. The solenoid system of claim 6, wherein the sensor is disposed at least partially radially inward of an outer circumference of the permanent magnet.

8. The solenoid system of claim 5, wherein the sensor is configured to detect a proximity of the sensor to the permanent magnet.

9. The solenoid system of claim 5, wherein the sensor is configured such that the sensor does not detect the magnetic field of the permanent magnet when the armature is in the other of the extended position or the retracted position.

10. The solenoid system of claim 5, wherein the sensor is between the housing and a pole of the permanent magnet when the armature is in the extended position and when the armature is in the retracted position.

11. The solenoid system of claim 5, wherein the electromagnetic device includes a spring that biases the armature toward one of the extended position or the retracted position.

12. The solenoid system of claim 5, wherein the permanent magnet is disposed at a second end of the armature that is opposite the first end of the armature.

13. The solenoid system of claim 12, wherein when the armature is in the extended position, the first end of the armature extends through an aperture in a first end of the housing, and wherein when the armature is in the retracted position, the second end of the armature extends axially through an aperture in a second end of the housing that is opposite the first end of the housing.

14. A solenoid system comprising:
an electromagnetic device including a housing, an armature, and a solenoid coil, the solenoid coil configured to move the armature axially between an extended position and a retracted position relative to the housing, wherein when the armature is in the extended position, a first end of the armature extends further in a first direction relative to the housing than when the armature is in the retracted position;
a permanent magnet fixedly coupled to the armature for common axial movement therewith, the permanent magnet having a first pole at a first axial end of the permanent magnet and a second pole at a second axial end of the permanent magnet;
a sensor fixedly coupled to the housing and configured to detect a magnetic field of the permanent magnet when the armature is in one of the extended position or the retracted position, wherein the sensor is disposed axially between the first and second poles of the permanent magnet when the armature is in the other of the extended position or the retracted position.

15. The solenoid system of claim 14, wherein the sensor is disposed axially between the permanent magnet and the housing when the armature is in the one of the extended position or the retracted position.

16. The solenoid system of claim 15, wherein the sensor is disposed radially outward of an outer circumference of the permanent magnet.

17. The solenoid system of claim 14, wherein the sensor is configured such that the sensor does not detect the magnetic field of the permanent magnet when the armature is in the other of the extended position or the retracted position.

18. The solenoid system of claim 14, wherein the electromagnetic device includes a spring that biases the armature toward one of the extended position or the retracted position.

19. The solenoid system of claim 14, wherein the permanent magnet is disposed at a second end of the armature that is opposite the first end of the armature.

20. The solenoid system of claim 19, wherein when the armature is in the extended position, the first end of the armature extends through an aperture in a first end of the housing, and wherein when the armature is in the retracted position, the second end of the armature extends axially through an aperture in a second end of the housing that is opposite the first end of the housing.
